(19) United States
(12) Patent Application Publication
(10) Pub. No.: US 2006/0016278 A1
(43) Pub. Date: Jan. 26, 2006

(54) Steering wheel vapor collection and sensing system using suction

(76) Inventor: Landon Duval, Huntington Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/899,826

(22) Filed: Jul. 26, 2004

(51) Int. Cl. G01N 1/00

(52) U.S. Cl. 73/864; 73/863.01

(57) ABSTRACT

A gas manifold is configured for encircling a steering wheel, and formed, in cross-section, as a crescent shape having an exterior concave panel conforming to the shape of the steering wheel for nesting therearound, and an exterior convex panel joined with the concave panel to form a hollow space between the panels. The convex panel provides plural first through-apertures for admitting vapors into the hollow space within the gas manifold. An internal vapor sensing circuit is mounted within the hollow space for contact with the vapors. A tubular conductor is in vapor-flow communication with the manifold for drawing the vapors by suction, through the manifold via the first through-apertures. Electrical conductors join the internal vapor sensing circuit with an external control circuit for electrical signal communication, establishing control of an ignition circuit of the motor vehicle.

### BACKGROUND OF THE INVENTION

1. Related Applications

This application is being filed simultaneously with a related co-pending application entitled, “Steering Wheel Vapor Collection and Sensing System Using a Chemical Element,” and which describes a related apparatus and method for detecting vapors in an automotive steering wheel.

2. Incorporation by Reference

Applicant(s) hereby incorporate herein by reference, any and all U.S. patents and U.S. patent applications cited or referred to in this application.

3. Field of the Invention

This invention relates generally to vapor collection systems and especially for collection of trace amounts of an alcohol containing substance carried by vapors, such as the breath analyzers used by law enforcement agencies where the breath of a driver is subject to analysis; and more particularly to a steering wheel mounted structure for collection and analysis of such vapors as partial pressures.

4. Description of Related Art

The following art defines the present state of this field:

Heim, U.S. Pat. No. 4,090,078 describes a method for determining the alcohol content in the exhaling respiratory air using an alcohol measuring instrument and measuring the alcohol content when the exhaling air transmits the determined value of the alcohol concentration. This determined value of alcohol concentration occurs when the time variation related to the height of the alcohol signal is below a predetermined threshold value and the velocity of flow of the exhaling air is above a given value and is maintained without interruption for a given time. The apparatus includes an infrared measuring instrument which is connected into the respiratory air current and measures the alcohol concentration of the exhaling air. This value is applied to an indicator through a linear gate when an AND-gate is triggered by threshold comparators and a timing element activated by a threshold comparator.

Leichnitz, U.S. Pat. No. 4,277,251 describes a method of determining the alcohol content of air exhaled by a person using a flow through testing tube having an alcohol indicating material therein and a sampling tube to which the air is directed which has a material therein for retaining the alcohol of the breathing air and also using a suction pump comprises cooling the sampling tube, passing the exhaled air through the cooled sampling tube, measuring a volume of the air passing through the cooled sampling tube, heating the sampling tube and connecting the suction pump to the sampling tube to suck flushing air through the heated tube and then through the testing tube. The sampling tube advantageously contains a silica gel to retain the alcohol therein. The volume measuring device may be a measuring bag.

Hutson, U.S. Pat. No. 4,363,635 describes a method and apparatus for discriminating between alcohol and acetone in a breath sample and accurately measuring the alcohol level when acetone is present in the sample. The breath sample is measured with two different types of detectors and their outputs compared. One detector uses the principles of infrared (IR) absorption, the other detector is a semiconductor, commonly called a Taguci cell, or its equivalent. Automatic correction is provided for variations in sensitivity of the semiconductor.

Talbot, U.S. Pat. No. 4,649,027 describes a battery-operated portable breath tester. The breath tester includes a housing which defines a sleeve for receiving a wand. The wand defines an internal sample chamber, with a lamp at one end for providing infrared energy and a detector at an opposite end for receiving the infrared energy after it has passed through the sample to be tested. The wand defines opening extending from the internal sample chamber to the outside of the wand. The wand has an external shape providing a snug fit within the sleeve. As the wand is moved within the sleeve, gas is purged from the wand. The wand is connected to the housing by means of an electrical coil. The housing encloses a digital voltmeter including a digital display for providing a test readout. The digital voltmeter includes an oscillator which is coupled through a frequency divider and a transistor switch to the lamp. The lamp is switched on and off in accordance with the frequency output of the frequency divider to modulate the infrared energy emitted from the lamp at a selected frequency. A voltage regulator is connected to the lamp, and the lamp and voltage regulator are located in heat-exchange relationship with the sample chamber. This aids in raising the temperature of the sample chamber during testing in order to alleviate condensation.

Lopez, U.S. Pat. No. 4,749,553 describes a breath alcohol detector measuring and compensating for distance between the mouth of the individual exhaling breath into the ambient air and the detector, the atmospheric pressure, and the temperature. Blood alcohol content information is calculated using these compensation factors and a signal obtained from an electrochemical fuel cell which is indicative of the amount of alcohol or other gas contained in the sample. The detector also includes a reciprocally acting electromagnetically energized motor which drives a diaphragm pump to draw the sample into the electrochemical fuel cell.

Fukui, U.S. Pat. No. 4,849,180 describes an alcohol selective gas sensor including a detecting electrode and a semiconductor detecting element in contact with the detecting electrode, the semiconductor detecting element comprising tin oxide (SnO₂) and a metal oxide of at least one of alkaline earth metals (Be, Mg, Ca, Sr, Ba) carried by the tin oxide, the metal oxide being contained in an amount of about 0.5 mol % or above.

O'Donnell et al., U.S. Pat. No. 4,905,498 describes a gaseous detection system for detecting the existence of a certain gas and further the detection of a certain level or percentage of that certain gas within a certain environment. An example is use of the gas detection system in a motor vehicle to aid in determining when a driver of the motor vehicle may be driving under the influence of alcohol, and for providing an appropriate warning signal that may be viewed from the exterior of the motor vehicle. The system includes a sensor unit for sensing ethanol in the atmospheric contents of the motor vehicle's interior, for example, a unit for providing an actuation signal in response to the sensing unit, and a signal unit that generates a signal which can be utilized for many purposes, for example, causing at least some of the exterior lights on the motor vehicle to alternately flash on and off in a substantially non-standard pattern. The sensing unit may also be coupled with a digital read-out device or the like to indicate the amount of blood alcohol content of a person for evidentiary or like purposes.

Martin, U.S. Pat. No. 5,055,268 describes an air-borne chemical sensor system including a motor and impeller to draw an air sample into a housing containing a sensor which will provide a signal for display related to the amount of a particular air-borne chemical in a given air sample. The system is controllable by different duration activation of a single activating switch which can further control a secondary function, such as a flashlight.

Phillips, U.S. Pat. No. 5,220,919 describes a gaseous detection system for detecting the existence of a certain gas and further the detection of a certain level or percentage of that certain gas within a certain environment. An example is use of the gas detection system in a motor vehicle to aid in determining when a driver of the motor vehicle may be driving under the influence of alcohol, and for providing an appropriate warning signal that may be viewed from the exterior of the motor vehicle. The system includes a sensor unit for sensing ethanol in the atmospheric contents of the motor vehicle's interior, for example, a unit for providing an actuation signal in response to the sensing unit, and a signal unit that generates a signal which can be utilized for many purposes, for example, causing at least some of the exterior lights on the motor vehicle to alternately flash on and off in a substantially non-standard pattern. The sensing unit may also be coupled with a digital read-out device or the like to indicate the amount of blood alcohol content of a person for evidentiary or like purposes.

Forrester et al., U.S. Pat. No. 5,376,555 describes a method and infrared sensing device for determining the concentration of alveolar alcohol in a breath sample exhaled by a subject into an infrared sensing device. The presence of alcohol from the upper respiratory tract of the subject is detected by continuously monitoring alcohol and carbon dioxide, normalizing alcohol values with respect to carbon dioxide, calculating a difference between normalized alcohol concentration and carbon dioxide concentration over time, integrating (summing) the difference, and comparing the integrated difference with a threshold. This technique accurately and consistently detects the presence of mouth alcohol in the sample before the presence of carbon dioxide which originates in deep lung breath.

Steinberg, U.S. Pat. No. 5,743,349 describes a vehicle ignition interlock system including a non-invasive reader of a person's blood-alcohol concentration in combination with ignition interlock circuitry that prevents operation of a vehicle by an intoxicated person. The non-invasive blood-alcohol concentration reader, termed alcoh-meter, utilizes optical spectroscopic electromagnetic radiation technology to determine the alcohol levels in the blood. The alcoh-meter is preferably a dash mounted sensor for receiving a person's finger and absorbing incident light from a multiple wavelength light source and causing a light absorption reading to be generated based on the person's blood alcohol concentration in the finger tissue. After registering a reading, the results are compared electronically against a table of impaired/non-impaired levels of blood alcohol concentration. The impaired/non-impaired results are communicated to interlock circuitry that either enables, or disables start-up of the vehicle. If an impaired status is determined, the results are displayed instructing the operator to wait, or find a non-impaired operator.

Sohèege et al., U.S. Pat. No. 6,075,444 describes an arrangement for blocking the operation by an intoxicated operator of a machine or a motor vehicle. The arrangement has a measuring apparatus which determines the blood alcohol content of the operator and an evaluation unit connected to the machine or motor vehicle. The evaluation unit receives measurement data supplied by the measurement apparatus and enables the machine or motor vehicle when the measurement data satisfies at least one predetermined condition. The arrangement is improved in that the sobriety of the operator is recognized before the starting operation of the machine or motor vehicle without it being necessary to supply a breath sample. The measuring apparatus includes a gas sensor which is a sensor for measuring the blood alcohol content via permeation through the skin of the operator. The measuring apparatus is configured so that it can be worn by the operator preferably on the leg or arm.

Kaplan, U.S. Pat. No. 6,097,480 describes a vehicle interlock system which utilizes non-invasive, optically based methods for detecting and measuring levels of certain target chemical substances in the blood or tissues of a user in preventing operation of the vehicle by persons exhibiting higher (or lower) than prescribed levels of such chemicals. The system of the present invention is not limited to simply measuring blood alcohol levels as are presently available breathalizer-based interlock systems, but lends itself to use in detecting unacceptable systemic levels of virtually any chemical for which the system if programmed to measure. In addition, the present system includes components for positively identifying, and during the course of vehicle operation, re-identifying the intended user and alcohol or drug user testee.

Kuennecke, U.S. Pat. No. 6,183,418 describes the process for detection and for quantitative determination of substances emitted or perspired through the skin is derived from flow diffusion analysis. The measuring system conceived for this purpose uses a diffusion half cell through which an acceptor medium flows and which is closed by a membrane. For the duration of the measurement, the membrane is brought into contact with the skin or a closed gas volume formed over the skin. With the process and the related measuring system, the blood alcohol level can be determined with a good degree of precision indirectly via the quantity of (gaseous) ethanol emitted through the skin.

Duval, U.S. Pat. No. 6,620,108 describes an apparatus and method for assuring that a machine operator is not under the influence of a chemical, comprising a first sensor positioned proximally to the machine operator and adapted for measuring a vapor concentration proximal thereto, a second sensor positioned distally from the machine operator and adapted for measuring the vapor concentration distally from the operator, a device for comparing the proximal and distal vapor concentrations, and an automated remediating element responsive to the comparing device when the ratio of the first and the second vapor concentrations are within a specified range.

Our prior art search with abstracts described above primarily teaches the use of analyzing vapors produced in the exhalant of an individual and within an enclosed space such as the interior of an automobile. Thus, the prior art shows several solutions to the analysis of vapors and how to collect vapors. However, the prior art fails to teach a simple system that can avoid the use of breath analysis and yet be inexpensive by avoiding the very high sensitivity required of room air analyzers. NOTE The present solution is a gas manifold integral with a steering wheel which is able to detect ethanol secretion within the vapors of human perspiration from the contact between the skin and the steering wheel, i.e., excreted through the skin; analyzing ethanol vapors and confirming ethanol, as opposed to isopropyl or methanol, using an infrared spectrometric method to produce a control signal enabling automatic monitoring and urgent actions depending upon results. The present invention fulfills these needs and provides further related advantages as described in the following summary.

### SUMMARY OF THE INVENTION

Data has been collected on the number of accidents and accident related deaths on U.S. highways each year that are, at least in part, related to alcohol within the blood stream of drivers. This data shows that it would be wise to take steps to prevent motorists from driving when they are under the influence of alcohol. One solution to this problem is to install a device in existing and new automobiles, and other types of vehicles that will monitor and possibly prevent such dangerous operation. The present invention teaches certain benefits in construction and use of such devices which give rise to the objectives described below and forms at least a partial solution to this problem.

One preferred embodiment of the invention is a perforated, wrap-around system installed onto a steering wheel with adhesive. It may be used on automobiles, trucks, buses, boats, aircraft and other motor propelled vehicles. Once the system is adhered in place it becomes a permanent part of the steering wheel. The surface of a cover of the invention may be textured and colored as desired. Ethanol vapors from the hands is sensed as emitted by the sweat glands. Construction of the invention is in accordance with the best automotive practice and National Highway Transportation Safety Association. In a best mode preferred embodiment of the present invention, a gas manifold, preferably of a structural material such as metal or plastic, and preferably aircraft grade aluminum, is configured for encircling a steering wheel, and is formed, in cross-section, as a crescent shape having an exterior concave panel conforming to the shape of the steering wheel for nesting therearound, and an exterior convex panel joined with the concave panel to form a hollow space between the panels. The convex panel provides plural first through-apertures for admitting ethanol vapors into the hollow space within the gas manifold. An internal vapor sensing circuit, which may operate in accordance with any of the sited prior art, is mounted within the hollow space, attached by bonding, for instance, for contact with the vapors that flow into and through the hollow space. A tubular conductor, such as a plastic small gauge polyethylene tube, is in vapor-flow communication with the manifold and therefore draws the vapors by suction, into the manifold via the first through-apertures. Electrical conductors, such as small gauge insulated copper wires, join the internal vapor sensing circuit with an external control circuit for electrical signal communication, thereby establishing control of an ignition circuit of the motor vehicle. Alternately, the control circuit might control audible or visual devices to inform the driver that he/she is driving dangerously, or might control other devices for establishing location or other applications as deemed necessary to protect the driver, any passengers and the general public. Other embodiments of the present invention include steering wheels with built in manifold configurations. The present invention focuses attention on the use and consumption of ethanol by drivers, but other applications are possible for detecting other chemical agents released in human perspiration. Other applications include detecting other substances and conditions including: marijuana, human illness or chronic conditions such as high blood pressure, and even the chemical combination associated with a particular human to be able to detect that the vehicle is being operated by an unauthorized person.

A primary objective of the present invention is to provide an apparatus and method of use of such apparatus that yields advantages not taught by the prior art.

Another objective is to assure that an embodiment of the invention is capable of integrating vapor collection with a steering wheel.

A further objective is to assure that the vapor is drawn into the steering wheel assembly.

A further objective is to assure that the vapor is placed in contact with a vapor analyzer within the steering wheel assembly.

A still further objective is to assure that an electrical signal is directed to a control circuit.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view of the invention showing that the invention, in one embodiment, is placed onto a steering wheel of a motor vehicle;

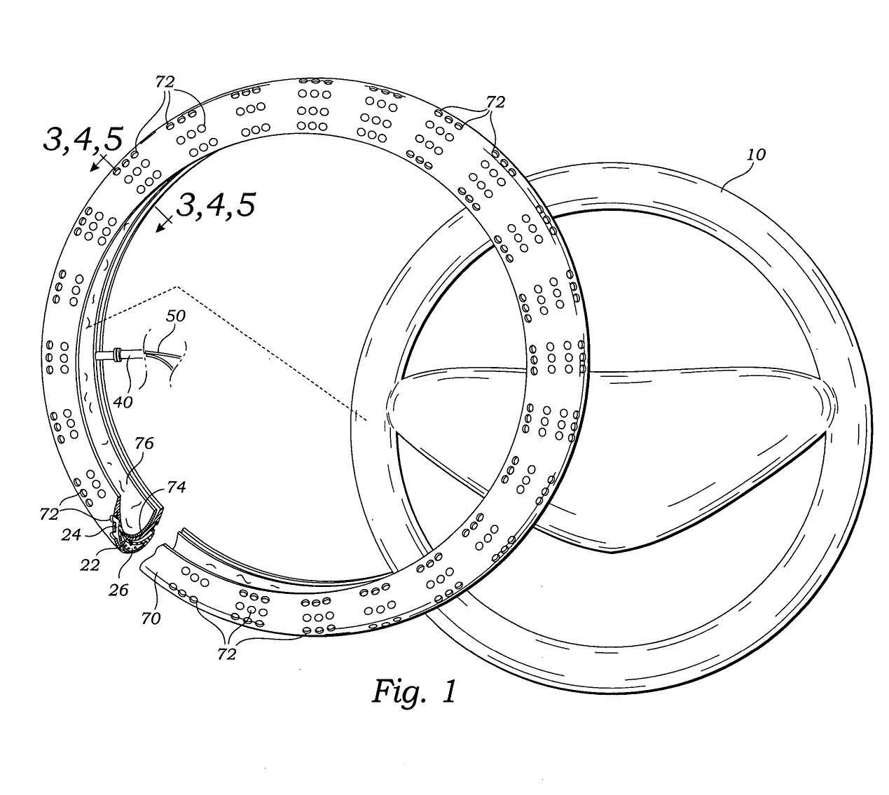

FIG. 2 is a perspective view thereof showing the invention in place on the steering wheel;

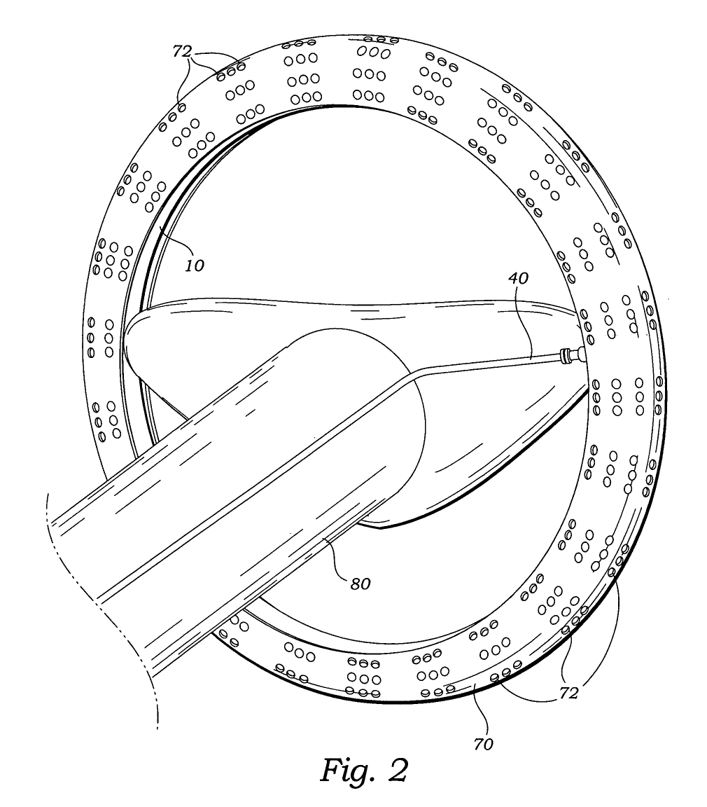

FIG. 3 is a sectional view taken along cutting line 3-3 in FIG. 1.

FIG. 4 is a sectional view similar to that of FIG. 3 wherein a manifold is bonded to the steering wheel;

FIG. 5 is a sectional view similar to that of FIG. 3 wherein the steering wheel takes the place of the manifold; and

FIG. 6 is a perspective view showing placement of the several elements of the invention in a motor vehicle.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

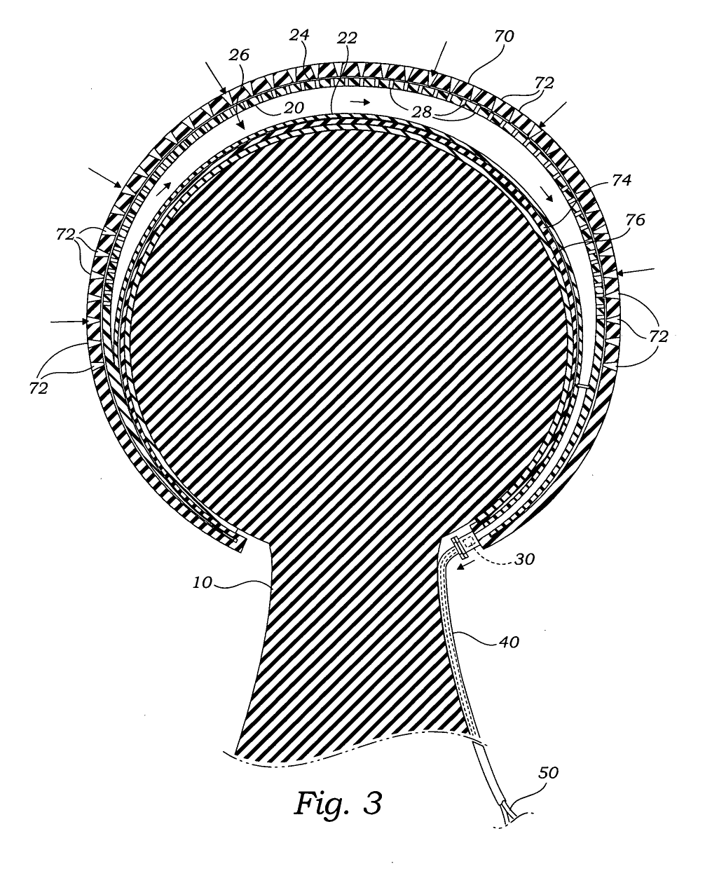

In a best mode embodiment shown in detail in the sectional view of FIG. 3 of the present invention a vapor collecting and analyzing apparatus is mounted on a motor vehicle steering wheel 10. The apparatus comprises a gas manifold 20 configured for encircling the steering wheel 10. The gas manifold 20 is formed, in cross-section, as a crescent shape having an exterior concave panel 22 conforming to the shape of the steering wheel 10 for nesting around it, and an exterior convex panel 24 joined with the concave panel 22, by welding or similar means, to form a hollow space 26 between the panels, 22, 24. The convex panel 24 has plural first through-apertures 28 for admitting vapors into the hollow space 26 within the gas manifold 20. An internal vapor sensing circuit 30 is mounted within the hollow space 26 for contact with the vapors that are caused to flow through the manifold 20, as will be described. A tubular conductor 40, such as a polyethylene tube defined to withstand a vacuum pressure without collapse is interconnected with a source of low pressure (vacuum), is placed in vapor-flow communication with the manifold 20 for drawing the vapors by suction, through the hollow space 26 via the first through-apertures 28. Electrical conductors 50, such as copper wires, join the internal vapor sensing circuit 30 with an external control circuit 60 thereby establishing electrical signal communication therebetween for establishing control of an ignition circuit of the motor vehicle, for instance, or for setting off an alarm or for enabling other appropriate actions.

A cover 70 of organic material, preferably a rubber, leather, etc., removably encircles and covers the steering wheel 10 and the gas manifold 20. The cover 70 provides plural second through-apertures 72 for admitting the vapors through the cover 70 and into the gas manifold 20. Preferably, an inner panel 74 of the cover 70, lies adjacent to the concave panel 22 of the gas manifold 20, and is positioned, sized and adapted for being bonded 76 to the steering wheel 20.

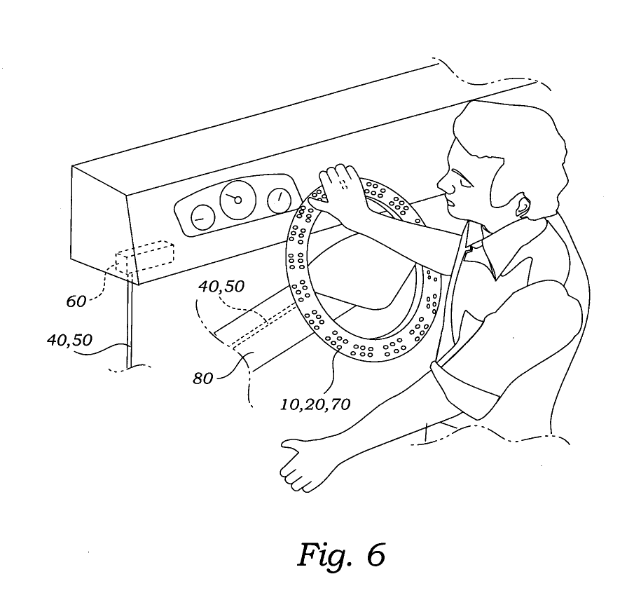

As shown in FIG. 6, the tube 40 with wires 50 running inside is routed from the manifold 20 to the steering column 80 and externally or internally along the column 80 to the control circuit 60 which is typically mounted within a dash board for a car, truck, boat or aircraft. The control circuit 60 contains a suction pump for producing a low pressure within tube 40 and a trigger circuit adapted for reacting to the signal from the vapor sensing circuit 30 via wires 50.

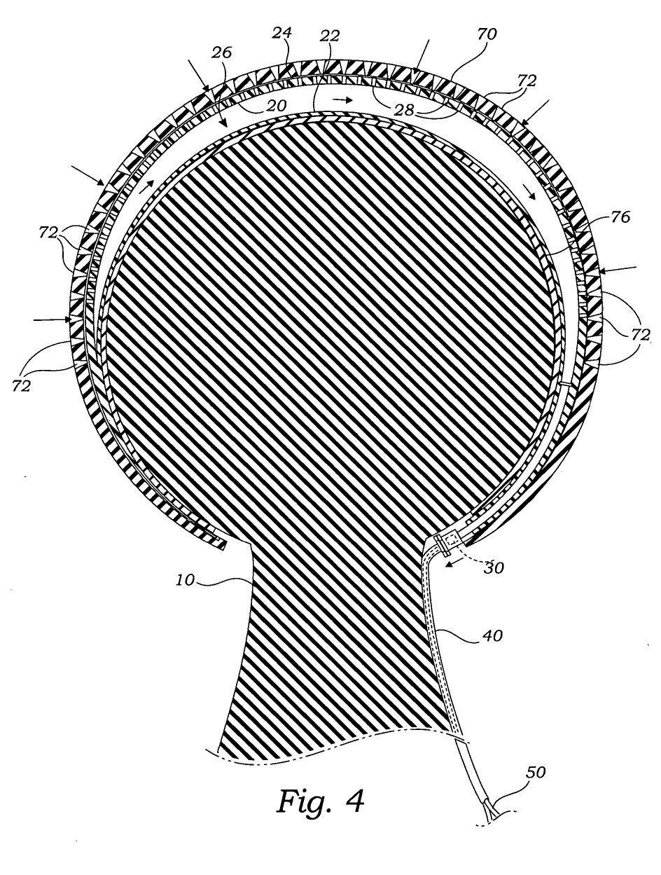

In an alternate embodiment shown in the sectional view of FIG. 4, the gas manifold 20 is formed integrally with the steering wheel 10, that is, the steering wheel 10 may be a molded to the manifold or otherwise factory assembled to the manifold without consideration of separating the two parts thereafter. Likewise, the cover 70 may be formed and joined, in assembly, to the manifold 20 and the steering wheel 10 so that the three parts are integral and not separable. Again, the manifold 20 may be fully enclosed within the cover 70.

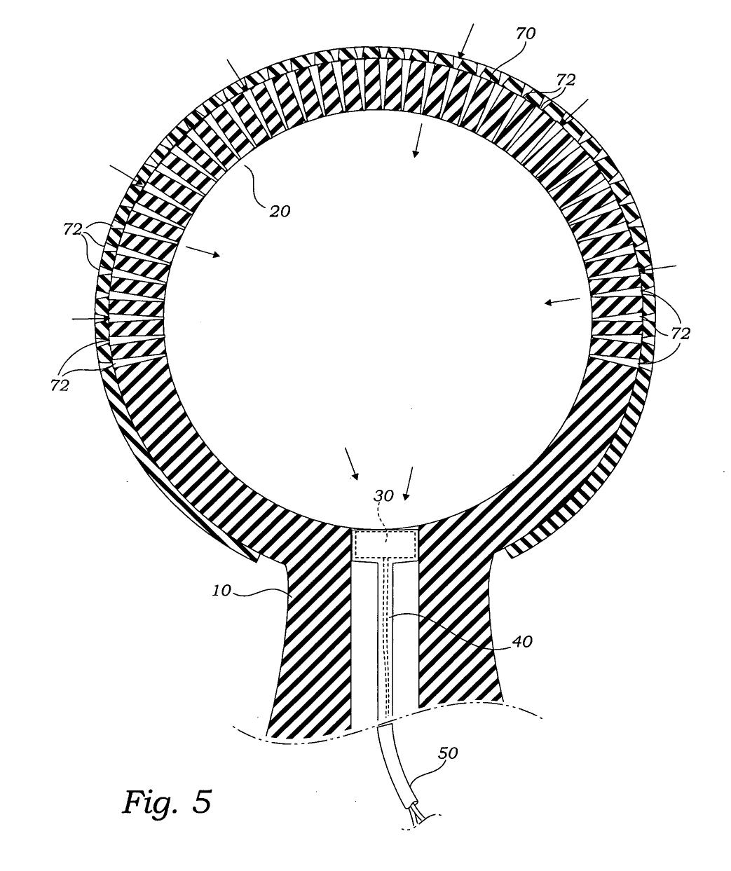

In a further alternate embodiment shown in the sectional view of FIG. 5, the steering wheel 10 itself, is the gas manifold 20. In this case the steering wheel is hollow providing the hollow space 26. The steering wheel 10 provides the plural first through-apertures 28 for admitting the vapors into the hollow space 26. The internal vapor sensing circuit 30, in this case, is mounted within the hollow space 26 within the steering wheel 10 for contact with the vapors therein. The tubular conductor 40 is in vapor-flow communication with the hollow space 26 within the steering wheel 10 for drawing the vapors by suction, through the steering wheel via the first through-apertures 28. The electrical conductors 50 join the internal vapor sensing circuit 30 with the external control circuit 60, as above described, for electrical signal communication for establishing control as described. In this case, the cover 70 may or may not be implemented in the invention. If it is used the cover is made an integral part of the steering wheel 10 and the second through-apertures 72 are place in correspondence and registration with the first through-apertures 28 so that vapor may flow through the cover 70 and into the hollow space 26 in the steering wheel 10.

In operation, the sensing circuit 30 may use a detector under the principles of infrared (1R) absorption, a Taguci cell as per the Hutson reference, a tin oxide (SnO₂) and a metal oxide of at least one of the alkaline earth metals (Be, Mg, Ca, Sr, Ba) carried by the tin oxide, the metal oxide being contained in an amount of about 0.5 mol % as per Fukui or the gas sensor of Sohèege et al. may be employed. Also, the process of using a diffusion half-cell described by Kuennecke may be employed.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A vapor collecting and analyzing apparatus for mounting on a motor vehicle steering wheel, the apparatus comprising: a gas manifold configured for encircling the steering wheel, the gas manifold formed, in cross-section, as a crescent shape having an exterior concave panel conforming to the shape of the steering wheel for nesting therearound, and an exterior convex panel joined with the concave panel to form a hollow space between the panels, the convex panel providing plural first through-apertures for admitting vapors into the hollow space within the gas manifold; an internal vapor sensing circuit mounted within the hollow space for contact with the vapors therein; and a tubular conductor in vapor-flow communication with the manifold for drawing the vapors by suction, through the manifold via the first through-apertures; electrical conductors joining the internal vapor sensing circuit with an external control circuit for electrical signal communication therebetween for establishing control of an ignition circuit of the motor vehicle.

2. The apparatus of claim 1 further providing a cover of organic material, the cover removably encircling and covering the steering wheel and the gas manifold; the cover providing plural second through-apertures for admitting the vapors into the gas manifold.

3. The apparatus of claim 2 wherein the gas manifold is fully enclosed within the cover, an inner panel of the cover, adjacent to the concave panel of the gas manifold, positioned, sized and adapted for bonding to the steering wheel.

4. The apparatus of claim 1 wherein the concave panel of the gas manifold is nested against and bonded to the steering wheel.

5. A vapor collecting and analyzing apparatus for use in a motor vehicle, the apparatus comprising: a steering wheel providing a hollow space therein forming a gas manifold; plural first through-apertures in the steering wheel for admitting vapors into the gas manifold; an internal vapor sensing circuit mounted within the hollow space for contact with the vapors therein; and a tubular conductor in vapor-flow communication with the manifold for drawing the vapors by suction, through the manifold via the first through-apertures; electrical conductors joining the internal vapor sensing circuit with an external control circuit for electrical signal communication therebetween for establishing control of an ignition circuit of the motor vehicle.

6. The apparatus of claim 5 further providing a cover of organic material integral to the steering wheel, the cover encircling and covering the steering wheel; plural second through-apertures in the cover positioned for admitting the vapors into the gas manifold.

7. A vapor collecting and analyzing apparatus for use in a motor vehicle, the apparatus comprising: a gas manifold integrally encircling a steering wheel, the gas manifold formed, in cross-section, as a crescent shape having an exterior concave panel conformal with the steering wheel and non-removably engaged therearound, and an exterior convex panel joined with the concave panel to form a hollow space between the panels, the convex panel providing plural first through-apertures for admitting vapors into the hollow space within the gas manifold; an internal vapor sensing circuit mounted within the hollow space for contact with the vapors therein; and a tubular conductor in vapor-flow communication with the manifold for drawing the vapors by suction, through the manifold via the first through-apertures; electrical conductors joining the internal vapor sensing circuit with an external control circuit for electrical signal communication therebetween for establishing control of an ignition circuit of the motor vehicle.

8. The apparatus of claim 7 further providing a cover of organic material, the cover encircling and covering the steering wheel and the gas manifold; the cover providing plural second through-apertures for admitting the vapors into the gas manifold.

9. The apparatus of claim 8 wherein the gas manifold is fully enclosed within the cover, an inner panel of the cover, adjacent to the concave panel of the gas manifold, bonded to the steering wheel.
